(19) United States
(12) Patent Application Publication
(10) Pub. No.: US 2010/0250796 A1
(43) Pub. Date: Sep. 30, 2010

(54) Establishing a Secure Channel between a Server and a Portable Device

(76) Inventors: David Jevans, Menlo Park, CA (US); Gil Spencer, Los Gatos, CA (US); Shannon Holland, Los Gatos, CA (US); Manish Pandey, San Jose, CA (US); Dan Simon, Santa Clara, CA (US)

Correspondence Address: CARR & FERRELL LLP, 2200 GENG ROAD, PALO ALTO, CA, 94303, US

(21) Appl. No.: 12/412,844

(22) Filed: Mar. 27, 2009

(51) Int. Cl. G06F 3/00; G06F 21/00

(52) U.S. Cl. 710/36; 713/185; 713/172

(57) ABSTRACT

Systems and method for forming a secure channel between a server and a portable storage device coupled to a host computer are presented. A message sequence is exchanged between the server and the portable storage device. The message sequence may pass transparently through the host computer to the portable storage device. The server and the portable storage device may be authenticated based on the message sequence. A secure channel may be established between the server and the portable storage device when the server and the portable storage device are authenticated. As such, the host computer, as well as any other interstitial device between the server and the portable storage device, cannot access information transferred via the secure channel.

### BACKGROUND OF THE INVENTION

1. Field of the Invention

The present invention relates generally to forming communication channels across networks. More specifically, the present invention relates to establishing a secure channel between a server and a portable storage device.

2. Related Art

Presently, data may be transferred directly between a server and a peripheral data storage device such as an external hard drive or a USB flash drive. Peripheral data storage devices are generally coupled to a computer that is networked with the server. The data that is transferred between such a peripheral data storage device and the server across a network may be accessible to third parties. That is, a third party may intercept a data stream between the peripheral data storage device and the server, and thus obtain the data included in that data stream. As such, there is a need for a secure channel between the peripheral data storage device and the server.

### SUMMARY OF THE INVENTION

Embodiments of the present invention allow a secure channel to be established between a server and a portable storage device coupled to a host computer.

In a first claimed embodiment, a method for forming a secure channel between a server and a portable storage device coupled to a host computer is disclosed. The method includes exchanging a message sequence between the server and the portable storage device. The message sequence may pass transparently through the host computer. The method also includes authenticating the server and the portable storage device based on the message sequence. Additionally, the method includes establishing a secure channel between the server and the portable storage device when the server and the portable storage device are authenticated.

In a second claimed embodiment, a system is set forth. The system includes a portable storage device coupled to a host computer and a server. The portable storage device and the server are communicatively coupled with a network. The portable storage device includes a device cryptography module stored in memory and executable by a processor to encrypt and decrypt information transferred between the portable storage device and the server. The portable storage device also includes a challenge generation module stored in memory and executable by a processor to generate a server challenge. The server includes a server cryptography module stored in memory and executable by a processor to encrypt and decrypt information transferred between the portable storage device and the server. In addition, the server includes a shared secret module stored in memory and executable by a processor to generate a shared secret.

A third claimed embodiment discloses a computer readable storage medium having a program embodied thereon. The program is executable by a processor to perform method for forming a secure channel between a server and a portable storage device coupled to a host computer. The method includes exchanging a message sequence between the server and the portable storage device, the message sequence passing transparently through the host computer; authenticating the server and the portable storage device based on the message sequence; and establishing a secure channel between the server and the portable storage device when the server and the portable storage device are authenticated.

### BRIEF DESCRIPTION OF THE DRAWINGS

FIG. 1 is a block diagram of an exemplary environment for practicing embodiments of the present invention.

FIG. 2 is a block diagram of an exemplary portable storage device employed in the environment of FIG. 1.

FIG. 3A is a block diagram of an exemplary device secure channel engine included in the portable storage device of FIG. 2.

FIG. 3B is a block diagram of an exemplary server secure channel engine included in a server employed in the environment of FIG. 1.

FIG. 4 is an exemplary message sequence chart illustrating establishment of a secure channel between a server and a portable storage device.

FIG. 5 is a flowchart of an exemplary method for establishing a secure channel between a server and a portable storage device.

### DETAILED DESCRIPTION OF EXEMPLARY EMBODIMENTS

The present invention provides methods and systems for establishing a secure channel between a server and a portable storage device that is generally coupled to a host computer networked with the server. Both the server and the portable storage device are equipped to encrypt and decrypt information that is sent and received therebetween. Additionally, the host computer will operate a control panel that acts as a conduit to transparently pass information through the host computer, in accordance with exemplary embodiments. Thus, a secure channel can be formed between the server and the portable storage device. As such, the host computer, as well as any other interstitial device between the server and the portable storage device, cannot decrypt or otherwise access information transferred via the secure channel.

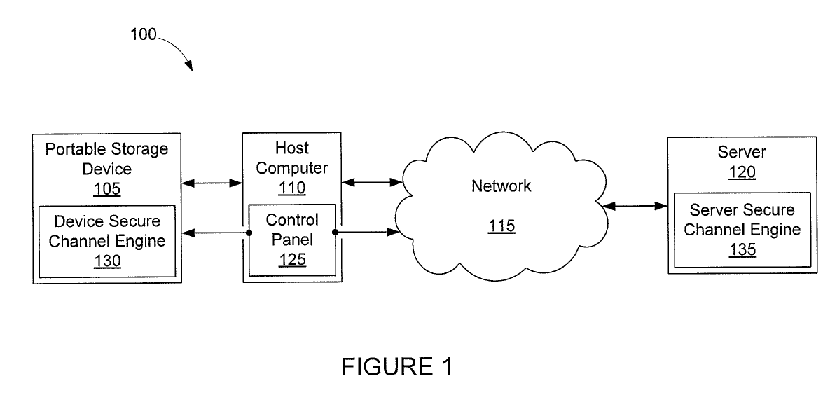

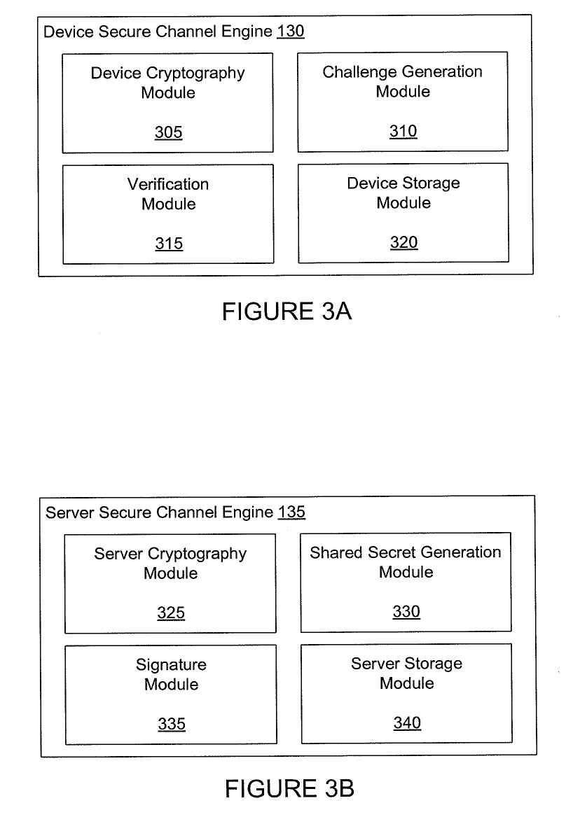

Referring now to FIG. 1, a block diagram of an exemplary environment 100 is presented. As depicted, the environment 100 includes a portable storage device 105, a host computer 110, a network 115, and a server 120. The portable storage device 105 is communicatively coupled with the host computer 110, which in turn in communicatively coupled with the network 115. The server 120 is also communicatively coupled with the network 115. It is noteworthy that these communicative couplings may be wireless or wired. Additionally, as illustrated in FIG. 1 and explained in further detail herein, the portable storage device 105 may communicate with the network 115 transparently through the host computer 110 via a control panel 125. Furthermore, as depicted, the portable storage device 105 includes a device secure channel engine 130, while the server 120 includes a server secure channel engine 135. The device secure channel engine 130 and the server secure channel engine 135 are discussed further in connection with FIG. 3A and FIG. 3B, respectively.

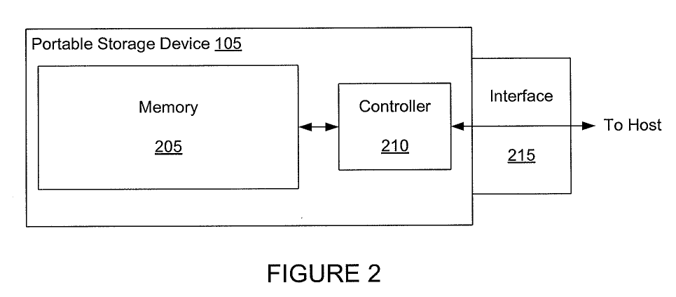

The portable storage device 105 may be any device that is portable and used to store digital information. For illustrative purposes, the portable storage device 105 is described herein in the context of a USB flash drive. The portable storage device 105 is discussed in further detail in connection with FIG. 2.

The host computer 110 includes any computing device that can interface with the portable storage device 105 and the network 115. Examples of the host computer 110 include a personal computer (PC), a personal digital assistant (PDA), a Smartphone, and other various devices. The host computer 110 includes one or more communications interfaces (not depicted) to facilitate communicative coupling with the portable storage device 105 and the network 115. Additionally, the host computer 110 includes a processor, memory such as RAM, and storage such as ROM (all not depicted). Those skilled in the art will be familiar with the components and functionality of computing devices such as the host computer 110.

As mentioned, the host computer 110 is depicted as including the control panel 125. According to exemplary embodiments, the control panel 125 may be effectuated by instructions that are executed by the processor of the host computer 110. These instructions may be stored within the portable storage device 105 and retrieved by the host computer 110 for execution. Alternatively, the instructions associated with the control panel 125 may be stored by the host computer 110, or stored remotely and accessed by the host computer 110 via the network 115.

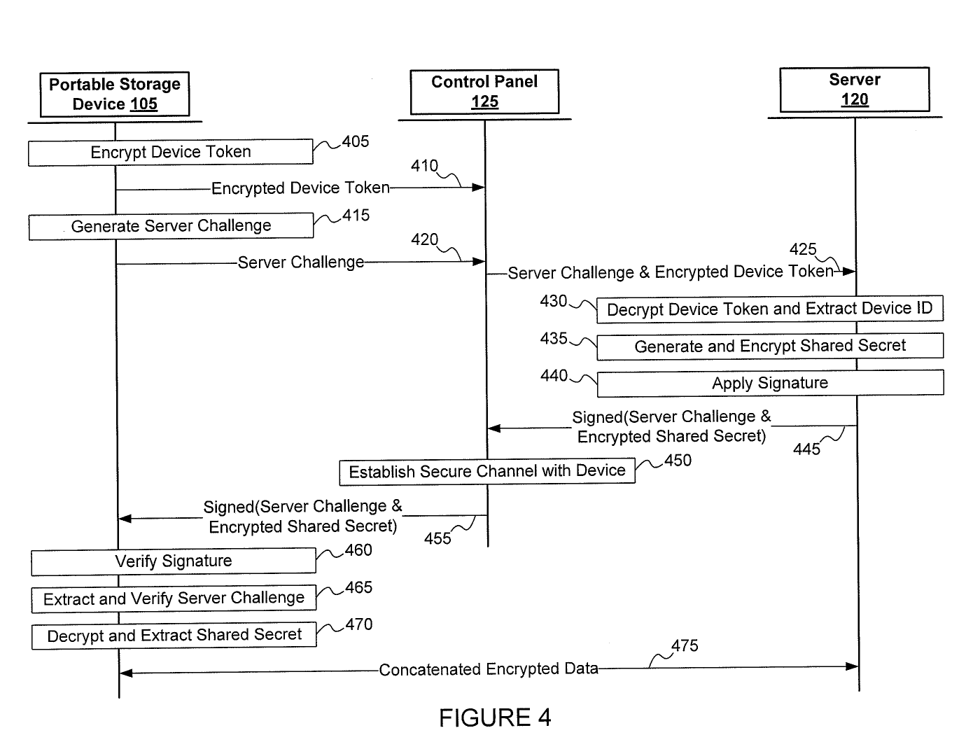

The control panel 125 may facilitate operation of a secure channel between the server 120 and the portable storage device 105. The control panel 125 may act as a conduit for transparently transferring information through the host computer 110 between the server 120 and the portable storage device 105. As such, the control panel 125 never decrypts or otherwise accesses any of that transferred information. This functionality of the control panel 125 is described further in connection with FIG. 4. In addition, the control panel 125 may also allow a user to manage digital information stored within the portable storage device 105.

The network 115 may be a wide-area network and include a private network (e.g., a leased line network) or a public network (e.g., the Internet). In some embodiments, the network 115 may be a local area network and cover a relatively small geographic range. Local area networks include wired networks (e.g., Ethernet) or wireless networks (e.g., Wi-Fi). The network 115 includes hardware and/or software elements that enable the exchange of information (e.g., voice and data) between the portable storage device 105 or the host computer 110 and the server 120. Routers or switches may be used to connect the network 115 with the host computer 110 and the server 120.

The server 120 includes any computing device that can interface with the network 115. Generally speaking, the server 120 provides services via the network 115 used by other computers and devices such as the host computer 110. The server 120 includes one or more communications interfaces (not depicted) to facilitate communicative coupling with the network 115. Additionally, the server 120 includes a processor, memory such as RAM, and storage such as ROM (all not depicted). Those skilled in the art will be familiar with the components and functionality of computing devices such as the server 120.

FIG. 2 is a block diagram of the exemplary portable storage device 105 employed in the environment 100 of FIG. 1. As mentioned, the portable storage device 105 may be any device that is portable and used to store digital information. The portable storage device 105 depicted in FIG. 2 includes a memory 205, a controller 210, and an interface 215.

The memory 205 may include a computer-readable storage medium. While common forms of computer-readable storage media include, for example, a floppy disk, a flexible disk, a hard disk, magnetic tape, any other magnetic medium, a CD-ROM disk, digital video disk (DVD), and any other optical medium, the memory 205 is described in the context of non-volatile memory that can be electrically erased and rewritten. Examples of such non-volatile memory include NAND flash and NOR flash. Additionally, the memory 205 may comprise other memory technologies as they become available.

The controller 210 may be a processor or microcontroller with an amount of on-chip ROM and/or RAM. The controller 210 is communicatively coupled with the memory 205 and the interface 215. Additionally, the controller 210 includes software and/or firmware that may execute various modules described herein. As such, the controller 210 functions as an intermediary between the host computer 110 and the memory 205. For example, the controller 210, or various modules executed thereby, may receive write commands from the host computer 110 and determine how data associated with those write commands is managed with respect to the memory 205.

As mentioned, the portable storage device 105 may be communicatively coupled with the host computer 110 either wirelessly or wired. The interface 215 facilitates this coupling by allowing information to be transferred between the portable storage device 105 and the host computer 110. In exemplary embodiments, the interface 215 includes a USB plug that is insertable into a mating USB port of the host computer 110. Alternatively, the interface 215 may include other standards for communicative coupling such as FireWire, Ethernet, Wireless USB, or Bluetooth. Furthermore, the interface 215 may comprise other interface technologies as they become available.

FIG. 3A is a block diagram of an exemplary device secure channel engine 130 included in the portable storage device 105. In accordance with various embodiments, the device secure channel engine 130, or certain modules thereof, may be included in the memory 205 and/or the controller 210. As depicted in FIG. 3A, the device secure channel engine 130 includes a device cryptography module 305, a challenge generation module 310, a verification module 315, and a device storage module 320. These modules may be executed by the controller 210 of the portable storage device 105 to effectuate the functionality attributed thereto. The device secure channel engine 130 may be composed of more or less modules (or combinations of the same) and still fall within the scope of the present invention. For example, the functionality of the device cryptography module 305 and the functionality of the challenge generation module 310 may be combined into a single module.

Execution of the device cryptography module 305 allows the controller 210 to encrypt and decrypt information stored by the memory 205 and transferred between the portable storage device 105 and the server 120. In exemplary embodiments, the device cryptography module 305 implements one or more of a variety of cryptographic technologies. Examples of cryptographic technologies include symmetric algorithms such as Twofish, Serpent, AES (Rijndael), Blowfish, CAST5, RC4, TDES, and IDEA, as well as asymmetric algorithms that use one key to encrypt given information and another key to decrypt that information. Those skilled in the art will be familiar with symmetric and asymmetric approaches to cryptography. The device cryptography module 305 may also be executable to concatenate information transferred between the portable storage device 105 and the server 120. Concatenation may be achieved through usage of message authentication code (MAC). Generally speaking, MAC describes a hashing mechanism with an associated secret that is used to identify a piece of data.

Execution of the challenge generation module 310 allows the controller 210 to generate a server challenge. The server challenge may include a set of random numbers and be used to confirm an identity of the server 120. Furthermore, the server challenge is generated through execution of the challenge generation module 310 on numerous occasions. For example, the server challenge may be generated each time a secure channel is established between the portable storage device 105 and the server 120.

Execution of the verification module 315 allows the controller 210 to verify various information sent by the server 120 to the portable storage device 105. In exemplary embodiments, the verification module 315 is executable to verify signatures applied by the server 120 to transferred information. The verification module 315 may also be executable to verify that a server challenge received back from the server 120 is consistent with a corresponding server challenge initially sent from the portable storage device 105 to the server 120. Additionally, it may be necessary to decrypt such a server challenge returned from the server 120. Decryption of the server challenge is achieved through execution of the device cryptography module 305.

The device storage module 320 may be configured to manage information associated with formation of a secure channel between the portable storage device 105 and the server 120. This information may be stored on the controller 210 or the memory 205, and is accessed through execution of the device storage module 320. In exemplary embodiments, this information includes a device token. The device token may be created when the portable storage device 105 is fabricated or at a later time. The device token may include a unique device identification (ID). The device ID includes a series of bytes that identify the portable storage device 105 in exemplary embodiments. In addition, the device token may include a public key. In general, public key cryptography is a method for secret communication between two parties without requiring an initial exchange of secret keys. The public key may be one of a set of keys that includes the public key and a private key. The private key may be retained by the portable storage device 105. The public key and the private key may be used by the cryptography module 305 to encrypt and decrypt information stored by the memory 205 and transferred between the portable storage device 105 and the server 120.

FIG. 3B is a block diagram of an exemplary server secure channel engine 135 included in the server 120. In accordance with various embodiments, the server secure channel engine 135, or certain modules thereof, may be included in the memory and/or storage of the server 120. As depicted, the server secure channel engine 135 includes a server cryptography module 325, a shared secret module 330, a signature module 335, and a server storage module 340. These modules may be executed by the processor of the server 120 to effectuate the functionality ascribed thereto. The server secure channel engine 135 may be composed of more or less modules (or combinations of the same) and still fall within the scope of the present invention. For example, the functionality of the server cryptography module 325 and the functionality of the shared secret module 330 may be combined into a single module.

Execution of the server cryptography module 325 allows the processor of the server 120 to encrypt and decrypt information stored by the memory and storage of the server 120 and transferred between the portable storage device 105 and the server 120. Much like device cryptography module 305, the server cryptography module 325 implements one or more of a variety of cryptographic technologies in accordance with exemplary embodiments. The server cryptography module 325 may also be executable to concatenate information transferred between the portable storage device 105 and the server 120.

Execution of the shared secret generation module 330 allows the processor of the server 120 to generate a shared secret. This shared secret may be distributed to the portable storage device 105. The shared secret includes an AES key concatenated with a MAC in exemplary embodiments. Those skilled in the art will be familiar with AES keys.

Execution of the signature module 335 allows the processor of the server 120 to digitally sign certain information transferred to the portable storage device 105. In exemplary embodiments, the signature module 335 may utilize an RSA signature. RSA is an algorithm for public key cryptography that is suitable for signing as well as encryption.

The server storage module 340 may be configured to manage information associated with a secure channel formed between the portable storage device 105 and the server 120. This information may be stored by the memory or storage of the server 120, and is accessed through execution of the server storage module 320. In exemplary embodiments, this information includes information associated with the portable storage device 105. For example, this information may include the device ID of the portable storage device 105.

FIG. 4 is an exemplary message sequence chart illustrating establishment of a secure channel between the server 120 and the portable storage device 105. As depicted, the message sequence illustrated in FIG. 4 may be implemented in the environment 100. The portable storage device 105 is in communication with the control panel 125 operated by the host computer 110. The control panel 125 is in communication with the server 120 via the network 115. The sequences and transmissions of the message sequence chart of FIG. 4 may be performed in varying orders. Additionally, sequences and transmissions may be added, subtracted, or combined and still fall within the scope of the present invention.

In sequence 405, a device token of the portable storage device 105 is encrypted. This encryption may be performed using a private key of the portable storage device 105. In exemplary embodiments, the controller 210 performs sequence 405 by executing the device cryptography module 305. As mentioned herein, the device token may include a device ID and a public key. In turn, the encrypted device token is sent to the control panel 125 in transmission 410. Transmissions may be sent over an HTTPS connection.

In sequence 415, a server challenge is generated at the portable storage device 105. The server challenge may include a set of random numbers and be used to confirm an identity of the server 120. The controller 210 performs sequence 415 by executing the challenge generation module 310 in exemplary embodiments. Accordingly, the server challenge is sent to the control panel 125 in transmission 420. After receiving transmissions 410 and 420, the control panel 125 transmits the server challenge and the encrypted device token to the server 120 in transmission 425.

In sequence 430, the encrypted device token received from the control panel 125 is decrypted and the device ID of the portable storage device 105 is extracted at the server 120. The processor of the server 120 performs sequence 430 by executing the server cryptography module 325. Additionally, the processor of the server 120 may execute the server storage module to look up information associated with the portable storage device 105 using the device ID.

In sequence 435, a shared secret is generated and encrypted at the server 120. As mentioned, the shared secret may include an AES key concatenated with a MAC. Generation of the shared secret may be performed by the processor of the server 120 through execution of the shared secret generation module 330, while encryption of the shared secret may be performed by the processor of the server 120 through execution of the server cryptography module 325.

In sequence 440, a signature is applied to the server challenge and the encrypted shared secret at the server 120. The signature includes an RSA signature in exemplary embodiments. The processor of the server 120 may perform sequence 440 by executing the signature module 335. As such, the signed server challenge and signed encrypted shared secret are transferred to the control panel 125 in transmission 445.

In sequence 450, the control panel 125 establishes a secure channel by acting as a conduit for transferring information between the server 120 and the portable storage device 105. Accordingly, the control panel 125 never decrypts or otherwise accesses any of that transferred information. The signed server challenge and signed encrypted shared secret are then passed on from the control panel 125 to the portable storage device 105 in transmission 455.

In sequence 460, the signature of the signed server challenge and signed encrypted shared secret are verified at the portable storage device 105. In exemplary embodiments, the controller 210 performs sequence 460 by executing the verification module 315. The controller 210 may also perform sequence 465, in which the server challenge is extracted and verified, by executing the verification module 315.

In sequence 470, the shared secret is decrypted and extracted at the portable storage device 105. The controller 210 performs sequence 470 according to exemplary embodiments by executing the device cryptography module 305. After the portable storage device 105 obtains the share secret in sequence 470, concatenated encrypted data may be sent via a secure channel between the portable storage device 105 and the server 120, as illustrated by transmission 475.

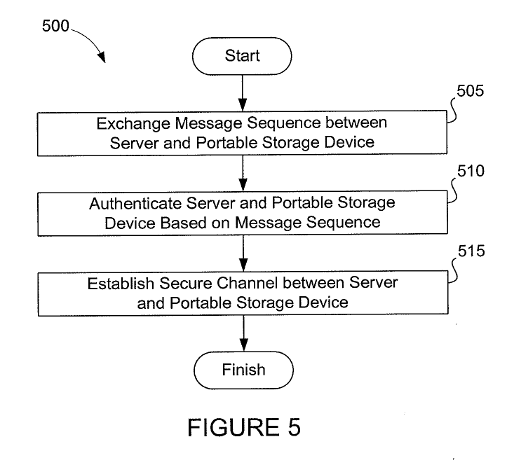

FIG. 5 is a flowchart of an exemplary method 500 for forming a secure channel between the server 120 and the portable storage device 105. The steps of the method 500 may be performed in varying orders. Steps may be added or subtracted from the method 500 and still fall within the scope of the present invention.

In step 505, a message sequence is exchanged between the server 120 and the portable storage device 105. It is noteworthy that the message sequence may pass transparently through the host computer 110 via the control panel 125 as described herein. In exemplary embodiments, the message sequence may be similar to that described in connection with FIG. 4.

In step 510, the server 120 and the portable storage device 105 are authenticated based on the message sequence. This authentication may be associated with successful decryption of certain transferred information. Additionally, this authentication may be associated with successful verification of digital signatures and/or challenges.

In step 515, a secure channel is established between the server 120 and the portable storage device 105 when the server and the portable storage device are authenticated. As such, the host computer 110, as well as any other interstitial device between the server and the portable storage device, cannot access information transferred via the secure channel.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for forming a secure channel between a server and a portable storage device coupled to a host computer, the method comprising:
exchanging a message sequence between the server and the portable storage device, the message sequence passing transparently through the host computer;
authenticating the server and the portable storage device based on the message sequence; and
establishing a secure channel between the server and the portable storage device when the server and the portable storage device are authenticated.

2. The method of claim 1, wherein exchanging the message sequence comprises:
receiving at the server a server challenge and an encrypted device token originating from the portable storage device;
decrypting the device token at the server;
generating at the server an encrypted shared secret based on the decrypted device token;
transferring the encrypted shared secret and the server challenge from the server to the portable storage device.

3. The method of claim 2, wherein the device token comprises a unique device identification of the portable storage device.

4. The method of claim 2, wherein the device token comprises a public key, the public key being one of a set of keys that includes the public key and a private key.

5. The method of claim 2, wherein the server challenge is generated by the portable storage device.

6. The method of claim 2, wherein the server challenge comprises a set of random numbers.

7. The method of claim 2, wherein the shared secret comprises a key concatenated with a MAC.

8. The method of claim 2, further comprising applying a signature to one or more of the server challenge or the encrypted shared secret.

9. The method of claim 8, wherein authenticating the server comprises verifying the signature.

10. A system for forming a secure channel, the system comprising:
a portable storage device coupled to a host computer; and
a server communicatively coupled with the host computer via a network;
the portable storage device comprising a device cryptography module stored in memory and executable by a processor to encrypt and decrypt information transferred between the portable storage device and the server, and a challenge generation module stored in memory and executable by a processor to generate a server challenge;
the server comprising a server cryptography module stored in memory and executable by a processor to encrypt and decrypt information transferred between the portable storage device and the server, and a shared secret module stored in memory and executable by a processor to generate a shared secret.

11. The system of claim 10, wherein a control panel operated by the host computer acts as a conduit to transparently pass information through the host computer.

12. The system of claim 10, wherein the portable storage device further comprises a verification module stored in memory and executable by a processor to verify information sent by the server to the portable storage device.

13. The system of claim 10, wherein the server further comprises a signature module stored in memory and executable by a processor to apply a signature to one or more of the server challenge or the shared secret

14. The system of claim 10, wherein the server challenge comprises a set of random numbers.

15. The system of claim 10, wherein the shared secret comprises a key concatenated with a MAC.

16. A computer readable storage medium having a program embodied thereon, the program executable by a processor to perform a method for forming a secure channel between a server and a portable storage device coupled to a host computer, the method comprising:
exchanging a message sequence between the server and the portable storage device, the message sequence passing transparently through the host computer;
authenticating the server and the portable storage device based on the message sequence; and
establishing a secure channel between the server and the portable storage device when the server and the portable storage device are authenticated.

17. The computer readable storage medium of claim 16, wherein exchanging the message sequence comprises:
receiving at the server a server challenge and an encrypted device token originating from the portable storage device;
decrypting the device token at the server;
generating at the server an encrypted shared secret based on the decrypted device token;
transferring the encrypted shared secret and the server challenge from the server to the portable storage device.

18. The computer readable storage medium of claim 17, wherein the device token comprises a unique device identification of the portable storage device.

19. The computer readable storage medium of claim 17, wherein the method further comprises applying a signature to one or more of the server challenge or the encrypted shared secret.

20. The computer readable storage medium of claim 17, wherein the server challenge is generated by the portable storage device.
